(19) United States
(12) Patent Application Publication
(10) Pub. No.: US 2004/0007995 A1
(43) Pub. Date: Jan. 15, 2004

(54) Vector control system for permanent magnet sychronous machines using an open-loop parameter observer

(75) Inventor: Zhenxing Fu, Ann Arbor, MI (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/193,829

(22) Filed: Jul. 11, 2002

(51) Int. Cl. H02P 1/18

(52) U.S. Cl. 318/254

(57) ABSTRACT

A method for vector control of a permanent magnet motor is provided. A torque command is provided from an open-loop observer circuit, which is manipulated to produce an AC voltage command to be applied to a permanent magnet motor. Also provided is a method for utilizing an open-loop observer circuit apparatus. The open-loop observer circuit apparatus takes three-phase inverter pole voltages and uses them to estimate electrical parameters of the permanent magnet motor A method for calculating three-phase inverter pole voltages is also provided, as is used in the open-loop observer circuit. A plurality of voltages are multiplied by the DC bus voltage to calculate the three-phase inverter pole voltages. Finally, a method for estimating electrical parameters is provided, as used in the open-loop observer circuit. Synchronous reference magnetic fluxes and currents are calculated, and these values are used to estimate the electrical parameters.

### BACKGROUND OF THE INVENTION

Permanent magnet (PM) synchronous machines are often used in applications where system efficiency, system size, torque/volume ratio, and dynamic response time are of concern. These concerns are particularly strong for motors with low power ratings or with large mechanical air gaps. Typical applications of PM synchronous machines, also known as sinusoidal brushless DC motors (BLDC), in the automotive industry include electrical power assisted steering (EPAS) motors, integrated starter alternator (ISA) motors, and traction motors for hybrid electric vehicles (HEV) and electric vehicles (EV). PM synchronous machines typically require a power supply with sinusoidal waveforms for excitation. Such machines are typically controlled using vector control techniques, also known as field orientation controls, to achieve fast dynamic responses, high efficiencies, optimal peak transient power or torque capabilities, and wide ranges of operating speeds.

In automotive underhood applications, such as EPAS, ISA, HEV or EV, the typical ambient temperature during use of the vehicle ranges from about −40 C. to about 125 C. For ISA and HEV systems in particular, motor operating temperature may reach about 200 C., even with forced liquid cooling. The wide operating temperature range requirements adversely affect the performance of the ISA or HEV systems, as most vector control systems are achieved using closed-loop control of motor currents with open-loop torque controls. Torque control or speed control of the machine is achieved by converting the required or demanded torques into current commands using motor parameters, and the controls of torque are open-looped. Since the motor parameters heavily depend on the operating conditions of the machine, such as the operating temperature and the level of magnetic saturation, there is a considerable amount of error associated with the conversion of torque commands to current commands.

In PM synchronous machines used in ISA, HEV, and EPAS, for example, the calculation of current commands from the torque command requires the use of the flux linkage value produced by the magnets per phase, λ_{PM}^{e}, as well as the motor inductance along each of the direct and quadradure axes, L_{d} and L_{q}, as demonstrated below in EQ. 1:

$${i}_{qs}^{{e}^{*}} = \frac{{T}_{e}^{*}}{\frac{3 P}{4} [ {λ}_{PM}^{e} + ( {L}_{d} - {L}_{q} ) {i}_{ds}^{{e}^{*}} ]} \qquad ( EQ . 1 )$$

In the above equation, flux linkage produced by the magnet, λ_{PM}^{e}, strongly depends on the operating temperature and magnetic saturation level of the machine. Further, the motor inductances heavily depend on the level of magnetic saturation in the steel used in the machine. Hence, if the flux linkage and the motor inductances are not updated corresponding to the ever-changing operating conditions of the machine, significant errors will develop in the calculation of the current command, and thus in the torque control. The overall torque control error, as measured from the torque commanded as compared to the actual torque delivered by the motor, could exceed ±20%, as shown in the summary of torque control errors listed in Table 1.

TABLE 1
Estimated Torque Control Errors for Uncompensated Vector Controlled
PMSM Motor

| Sources of Error | Error Percentage | Comments |
|---|---|---|
| PM Flux Linkage, λ^{e}_{PM}: | | |
| Br - Material | ±3% | Result of the tolerance of |
| | | the manufacturer's process |
| Br - Temperature | ±13% | −0.12%/C for −40° to |
| | | 180° C. |
| Air gap | ±4% | ±0.3 mm variation on |
| | | 1.0 mm gap |
| Inductance, L_{q}: | ±5% | 20% variation due to q-axis |
| | | saturation |
| Inductance, L_{d}: | ±2% | 10% variation due to d-axis |
| | | saturation |
| Current sensors: | ±1% | Built-in error in Hall effect |
| | | type sensors |
| Total Error in Torque | ±28% | |

Such high torque control error adversely affects the overall system performance, degrades driver feel, and reduces consumer satisfaction. Since the main source of contribution to excessive torque control errors is the electrical parameters of the machine, such as λ_{PM}, and L_{q}, improvements in estimating those parameters corresponding to the actual operating conditions of the machine are necessary.

### BRIEF SUMMARY OF THE INVENTION

According to one aspect of the present invention, there is provided a method for vector control of a permanent magnet motor. Estimated machine parameters are provided from an open-loop observer circuit and used to calculate a current command from a torque command. The current command is translated into a two-phase voltage command, which is transformed into a three-phase voltage command. That three-phase voltage command is then modulated into a three-phase PWM command. The three-phase PWM command is then applied to a permanent magnet motor.

According to another aspect of the present invention, there is provided a method for utilizing an open-loop machine parameter observer circuit apparatus. From input DC voltages, three-phase inverter pole voltages are calculated. These inverter pole voltages are converted into three-phase motor phase voltages, which are then transformed into two-phase motor voltages. From these two-phase motor voltages, the electrical parameters of the permanent magnet motor may be estimated.

According to yet another aspect of the present invention, there is provided a method for calculating three-phase inverter pole voltages with a voltage calculator. This voltage calculator is used in the open-loop observer circuit. A plurality of voltages and PWM duty cycles, as applied by the PWM signal generator, as well as the DC bus voltage, are provided as input. Each of the plurality of voltages is multiplied by the DC bus voltage. The multiplied voltages are then output as the three-phase inverter pole voltages.

According to still another aspect of the present invention, there is provided a method for estimating electrical parameters with an open-loop flux observer. This open-loop flux observer is used in the open-loop observer circuit. The stationary-reference magnetic fluxes are calculated, and transformed into synchronous reference magnetic fluxes. Meanwhile the synchronous-reference currents are filtered. The synchronous-reference magnetic fluxes and the filtered synchronous-reference currents are then used to estimate the electrical parameters.

Other aspects of the present invention will become apparent in connection with the following description of the present invention.

### BRIEF DESCRIPTION OF SEVERAL VIEWS OF THE DRAWINGS

FIG. 1 is a schematic diagram of a preferred embodiment of the control method of the present invention; and

FIG. 2 is a schematic diagram of a preferred embodiment of the open-loop machine parameter observer circuit of the present invention, and

FIG. 3 is a schematic diagram of a preferred embodiment of the inverter pole voltage estimation algorithm used in the voltage calculator of the open-loop observer circuit of the present invention, and

FIG. 4 is a schematic diagram of a preferred embodiment of the machine electrical parameter estimation algorithm used in the open-loop flux observer of the open-loop observer circuit of the present invention, and

FIG. 5 is a flow diagram of a preferred embodiment of the method of the present invention.

### DETAILED DESCRIPTION OF THE INVENTION

The apparatus to perform the embodiment of the present invention comprises four general elements: the PM synchronous motor, a position sensor, a power electronics inverter, and a control apparatus. The power electronics inverter apparatus may comprise a plurality of power electronics switches and current sensors, a DC bus filter capacitor, a gate drive circuitry to control said power electronics switches, a cold plate to cool said power electronics switches, and a housing. The control apparatus may comprise a number of analog electronic components on a printed circuit board, a microprocessor or digital signal processor chip, and a number of digital electronic components.

Specific conventions have been used in the nomenclature of the variables throughout this application. For example, a variable followed by “*” denotes a command value; in other words, a value for the variable representing an input by the vehicle supervisory controller or another internal process. Also, a variable followed by “\hat{ }” denotes a value estimated by a lookup table. Further, the values set forth in this application are preferably vector values. As such, a variable followed by a subscript “d” denotes the vector value in the direct axis, the direction of the current flow. This coordinate of a vector value is responsible for production of the magnetic field and magnetic flux. A variable followed by a subscript “q” denotes the vector value in the quadradure, or perpendicular, axis. This coordinate of a vector value is responsible for the production of torque.

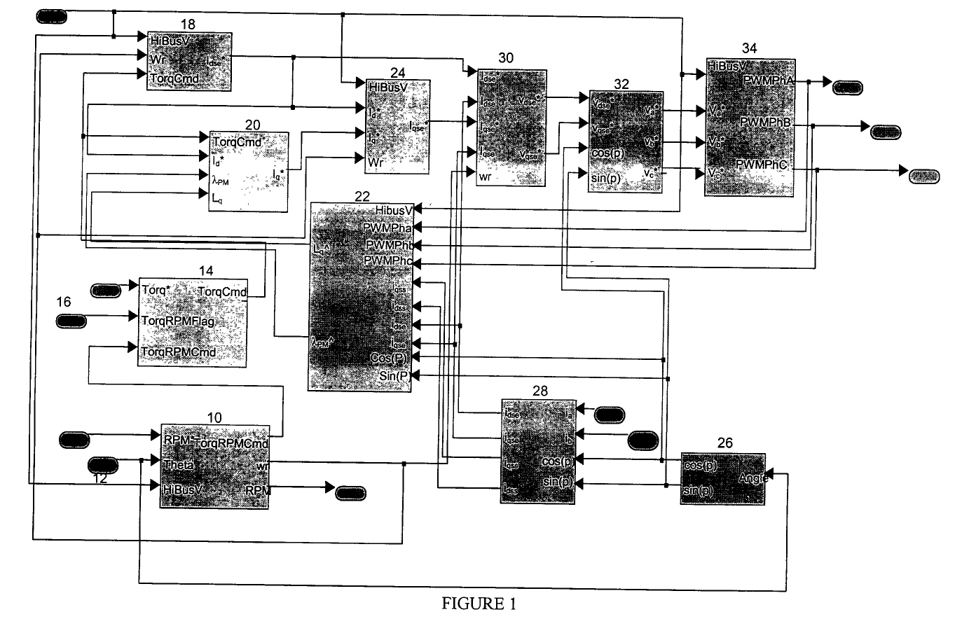

FIG. 1 is a schematic diagram showing an apparatus for implementing the preferred embodiment of the control method of the present invention.

In FIG. 1, speed regulator 10 calculates the mechanical speed of the motor in revolution per minute (RPM), electrical speed in radians per second, ωᵣ, and the torque required to achieve a speed command. The speed command, RPM*, is defined as the speed requested by the vehicle operator or supervisory controller. The speed commands may be given by conventional methods, such as the position of a vehicle operator's foot on an accelerator, or may be the result of a set speed on a cruise control system, or determined by the supervisory controller during gear shifts. To calculate these values, the speed command, RPM*, the motor position, Θ, and the power electronics converter voltage, HBusV are used as inputs. The motor position, Θ, is preferably measured by a motor position sensor 12 located preferably on the PM motor, more preferably located on the rotor shaft of the PM motor. The speed control of the speed regulator 10 is preferably obtained with the use of a conventional proportional-integral-derivative controller (“PID controller”), where the integrator is designed with anti-windup mechanisms to reduce error, as is known in the art. Preferably, these anti-windup mechanisms are provided to prevent integrators winding up after the saturation of the PID controller.

The required torque to achieve the speed command is then passed as an input to the mode selector 14. The mode selector 14 determines whether the apparatus is running in speed control mode or torque control mode, according to the position of a mode switch 16. The mode switch 16 is preferably a digital switch that can be controlled by the vehicle. The difference between the two modes is the controlled value. Speed control mode may be preferable during the gear shifts or engine cranking, in the case of an HEV, whereas torque control mode would be more preferable for regular driving and charging the battery. The mode selector 14 outputs a torque command. This torque command represents the torque requested, if the mode switch 16 is in torque control mode, or torque required to achieved the desired speed, if the mode switch 16 is in speed control mode.

The flux current strategizer 18 is designed to calculate the magnetizing (d-axis) current, I_{ds}^{e}*. The flux current strategizer 18 takes as input motor electrical speed in rad/s, ωᵣ, the torque command, and the battery voltage. By using a “maximum torque per ampere” strategy for the entire operating speed range, including constant power operation, as is known in the art, I_{ds}^{e}* may be obtained.

The current decoupler 20 calculates the required q-axis current, I_{q}*, for the motor to deliver the required torque command, based on EQ. 1 above. The current decoupler 20 takes I_{ds}^{e}*, the torque command, and the values of λ_{PM}^{e}\hat{ } and L_{q}\hat{ } received from an open-loop observer circuit 22, as will be discussed below, as input. EQ. 1 is applied to obtain an output of the required q-axis current, I_{q}*. This calculated q-axis current command, I_{q}*, is clamped by limiter 24. The maximum current and voltage capabilities of the power electronics inverter driven motor system are used to determine the range in which I_{q}* will be clamped by the limiter 24. Often, upper and lower limits are established from extensive modeling and measurements of the physical system. This check is necessary, as above, to prevent the system from exceeding the current and voltage limits and to ensure stable operation of the system.

Meanwhile, the motor position sensor 12 is used as input in a position converter 26 to compute the sine and cosine values of the rotor electrical position, sin(Θ) and cos(Θ). These sine and cosine values are used in a vector rotation translator 28 to transform motor currents from stationary reference coordinates to synchronous reference coordinates, and vice versa. Preferably, the vector rotation translator would use a Park transformation algorithm, as is known in the art. In the preferred embodiment of FIG. 1, the vector rotation translator 28 is a Park transformation. The vector rotation translator 28 calculates d-axis and q-axis currents in synchronous reference coordinates, I_{ds}^{e} and I_{qs}^{e} from the motor phase currents in stationary reference coordinates, iₐ and i_{b}, by using appropriate sine and cosine values of the rotor electrical position Θ.

The synchronous current regulator 30 calculates the voltages needed to regulate the d-axis and q-axis currents, I_{ds}^{e} and I_{qs}^{e}, according to the current commands, I_{ds}^{e}* and I_{qs}^{e}*. As part of this calculation, the synchronous current regulator 30 also calculates the d-axis and q-axis current regulation errors, ΔI_{d} and ΔI_{q}. They are internally used in the calculations of the synchronous current regulator 30 as inputs to conventional PID controllers that regulate the values of I_{ds}^{e} and I_{qs}^{e}. As earlier, anti-windup mechanisms are preferably provided in this PID controller. Additionally, to reduce the noise transmission through out the control system and to improve the dynamics, voltage feed forward compensations are preferably used. Voltage feed forward compensation reduces the effect of the coefficients used in the operation of a PID controller, and thereby reduces noise transmission. The required synchronous reference frame voltages needed to regulate d and q axis current commands are obtained by adding the outputs of PID controllers and voltage feed forward compensations. After applying proper voltage limits, the voltage commands in the synchronous reference coordinates, V_{ds}^{e}* and V_{qs}^{e}*, are determined.

A second vector rotation translator 32 is then used to translate the synchronous reference coordinates, the mathematical side of the present invention, back to stationary reference coordinates, representative of the physical side of the present invention. The current command vector, as defined by I_{ds}^{e}* and I_{q}*, is a purely mathematical construct—it has no specific representation in the physical world; instead, it merely decouples the effect of the motor phase currents according to their contributions to the magnetic flux and the torque. This representation of the current command vector yields quick and efficient control of the motor. However, the physical manifestation of a PM synchronous motor is a multi-phase system; preferably a three-phase system. The voltage needed in each of these phases, as per the current command, should preferably be calculated in order to actually, apply the current command vector to the physical PM motor.

In a preferred embodiment such as FIG. 1, the second vector rotation translator 32 is an inverse Park transformation. The second vector rotation translator 32 translates the voltage required in synchronous, mathematical reference coordinates to these needed in stationary, physical reference coordinates. The voltages required represented in stationary reference coordinates are referred to as vₐ*, v_{b}* and v_{c}* in FIG. 1.

The voltages, as expressed in stationary reference coordinates, represent the actual voltages to be applied to the motor via a power electronics inverter to regulate the current command, and thereby the torque command. Preferably, the waveform of the required voltages is sinusoidal, or AC current. The sinusoidal voltages required are realized preferably by providing sinusoidally pulse width modulated (“PWM”) signals to the gate drive circuitry of the power electronics inverter. The gate drive circuitry controls the power electronics inverter so as to produce sinusoidally PWM modulated voltages to the motor. A PWM signal generator 34 is designed to calculate the required PWM signals from the voltage required in stationary reference coordinates.

The PWM signal generator 34 uses a space vector modulation technique to synthesize sinusoidal voltage waveforms for minimizing voltage harmonics and improved use of effective inverter voltage. Such a space vector modulation technique is known in by those of skill in the art. Battery or DC voltage is accepted as an input of the PWM signal generator 34, and is adapted to the PWM signals. The individual PWM signals are sent to the gate drive circuitry to control the turn-on and turn-off of the inverter. Thereby, the power electronics inverter is able to supply controlled electric power with the proper magnitude and frequency to the PM motor, thus producing the commanded motor current and/or torque.

In a preferred embodiment, values for the inductance and the magnetic flux, λ_{PM}^{e}, corresponding to the present operating conditions of the machine are calculated from the open-loop observer circuit 22. The mathematics of the open-loop observer 22 reflects the equivalence between the two reference coordinate frames of the system—the stationary reference frame (the system as viewed by an outside observer) and the synchronous rotating reference frame (the system as viewed by an observer rotating with the PM machine rotor). It is the equivalence between these reference frames that give the proper governing equations.

With reference to the synchronous rotating reference frame, the governing equations of a permanent magnet synchronous machine are as follows:

$$\begin{matrix}{V}_{qse} = {R}_{s} {i}_{qse} + \frac{ⅆ {λ}_{qse}}{ⅆ t} + {ω}_{r} {λ}_{dse} \\ {V}_{dse} = {R}_{s} {i}_{dse} + \frac{ⅆ {λ}_{dse}}{ⅆ t} - {ω}_{r} {λ}_{qse} \\ \frac{ⅆ {ω}_{r}}{ⅆ t} = \frac{P}{2 J} ( {T}_{e} - {T}_{l} - {B}_{m} {ω}_{r} - {T}_{f} )\end{matrix}$$

The values of λ_{qse}, λ_{dse} and Tₑ are defined by the following equations:

λ_{qse}=L_{q}i_{qse}

λ_{dse}=L_{d}i_{dse}+λ_{PM} (EQ.2)

$${T}_{e} = \frac{3 P}{4} [ {λ}_{PM} {i}_{qse} + ( {L}_{d} - {L}_{q} ) {i}_{dse} {i}_{qse} ]$$

In the above equations, the other variables represent (with the proper units of the variables following in brackets):

Rₛ=Motor phase resistance, [Ohms]

L_{d}=d-axis inductance, [Henries]

L_{q}=q-axis inductance, [Henries]

ωᵣ=Motor electrical angular velocity, [Rads/s]

P=Number of magnetic poles

Tₑ=Developed electromagnetic torque, [Nm]

Tₗ=Load torque, [Nm]

T_{f}=Friction torque, [Nm]

Bₘ=Viscous damping coefficient, [Nm/Rads/s]

J=Moment of inertia of the motor [Nm/Rads/sec2]

i_{dse}=d-axis current in synchronous frame, [Amp]

i_{qse}=q-axis current in synchronous frame, [Amp]

v_{dse}=d-axis voltage in synchronous frame, [Volt]

v_{qse}=q-axis voltage in synchronous frame, [Volt]

λ_{dse}=d-axis flux linkage in synchronous frame, [V/sec]

λ_{qse}=q-axis flux linkage in synchronous frame, [V/sec] and

λ_{PM}=PM flux linkage in synchronous frame, [V/sec]

The governing equations in the stationary reference frame are:

$$\begin{matrix}{V}_{qss} = {R}_{s} {i}_{qss} + \frac{ⅆ {λ}_{qss}}{ⅆ t} \\ {V}_{dss} = {R}_{s} {i}_{dss} + \frac{ⅆ {λ}_{dss}}{ⅆ t} \\ \frac{ⅆ {ω}_{r}}{ⅆ t} = \frac{P}{2 J} ( {T}_{e} - {T}_{l} - {{B}^{5}}_{m} {ω}_{r} - {T}_{f} )\end{matrix}$$

The corresponding dynamic equations in state variable form are:

$$\begin{matrix}\begin{matrix}\frac{ⅆ {λ}_{qss}}{ⅆ t} = {V}_{qss} - {R}_{s} {i}_{qss} \\ \frac{ⅆ {λ}_{dss}}{ⅆ t} = {V}_{dss} - {R}_{s} {i}_{dss}\end{matrix} \\ \frac{ⅆ {ω}_{r}}{ⅆ t} = \frac{P}{2 J} ( {T}_{e} - {T}_{l} - {B}_{m} {ω}_{r} - {T}_{f} )\end{matrix} \qquad ( EQ . 3 )$$

And the stator flux vectors are defined as:

λ_{qss}=L_{q}i_{qss} (EQ. 4)

λ_{dss}=L_{d}i_{dss}+λ_{PMss} (EQ. 5)

Where the variables represent:

i_{dss}=d-axis current in stationary frame, [Amp]

i_{qss}=q-axis current in stationary frame, [Amp]

v_{dss}=d-axis voltage in stationary frame, [Volt]

v_{qss}=q-axis voltage in stationary frame, [Volt]

λ_{dss}=d-axis flux linkage in stationary frame, [V/sec]

λ_{qss}=q-axis flux linkage in stationary frame, [V/sec]

λ_{PMss}=PM flux linkage in stationary frame, [V/sec]

From the above equations, the magnetic flux linkage and inductances of the machine corresponding to the actual operating conditions can be estimated, assuming that the rotor position, the phase currents and the phase voltages are known, preferably via sensor mechanisms. For machines with high voltage ratings, such as those used in HEV and EV applications, measurements of phase voltage are expensive: In a preferred embodiment of the present invention, machine phase voltages are estimated using the measured DC bus voltage of the power electronics inverter, as well as PWM duty cycle commands, internally calculated by the software of the PWM signal generator 34. This estimation technique results in a low-cost solution for estimating machine phase voltages.

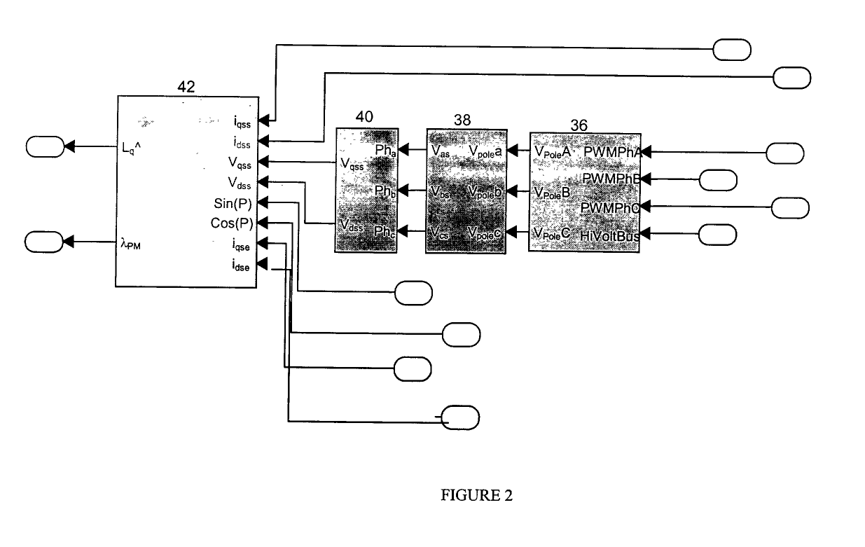

The open-loop observer circuit 22 shown in FIG. 1 utilizes this low-cost phase voltage estimation approach. The open-loop observer circuit 22 takes the DC bus voltage, the motor phase currents as transformed by the vector rotation translator 28, and the sine and cosine of the measured rotor electrical position as measured by position converter 26 as inputs. Based on EQS. 2, 3, 4, and 5, the open-loop observer then estimates the electrical parameters corresponding to the actual operating conditions of the machine. The electrical parameters estimated preferably include those required by current decoupler 20 to properly convert torque commands into machine current commands in a real-time time frame, more preferably the values of magnetic flux linkage, λ_{PM}, and q-axis inductance, L_{q}. Further details of the open-loop observer circuit 22 are given in FIGS. 2, 3, and 4.

FIG. 2 is a schematic diagram of a preferred embodiment of the open-loop machine parameter observer circuit 22 of the present invention. Voltage calculator 36 estimates the inverter pole voltages across the three low-side power switches. The voltage calculator makes its estimations based on the measured DC bus voltage of the inverter and the voltage signals as calculated by and received from the PWM signal generator 34. A voltage converter 38, as is known in the art, translates the three-phase inverter pole voltages estimated by the voltage calculator 36 into corresponding three-phase motor phase voltages. The voltage calculator 36 and the voltage converter 38 are able to determine the motor phase voltages at a low cost and a relatively high accuracy. These values are required in subsequent operations to estimate machine electrical parameters, and therefore must be reliably calculated at a minimum cost.

The three-phase stationary-reference motor voltages are then converted to an equivalent two-phase motor voltage by a voltage transformer 40. Preferably, this transformation is performed by the voltage transformer 40 via a Clark transformation algorithm, as is well known in the art. These resultant two-phase motor phase voltages are denoted by V_{dss} and v_{qss} in both FIG. 2 and EQ. 3.

The open-loop flux observer 42 takes v_{dss}and v_{qss} as input, along with the transformed motor electric currents and position information calculated or sensed by the control method apparatus of FIG. 1, as earlier discussed. These inputs are utilized by the open-loop flux observer 42 to estimate both the magnetic flux linkage, λ_{PM}^{e}\hat{ } and, and q-axis inductance, L_{q}\hat{ }.

The preferred embodiment of the open-loop observer circuit 22 of the present invention does not estimate the d-axis inductance, L_{d}. The L_{d} inductance value is not estimated in this preferred embodiment due to the relatively small variation of its value, as compared to the wider variation of magnetic flux linkage values and q-axis inductance values. The value of L_{d} is only minimally affected by changes in the machine operating conditions, as opposed to the values of λ_{PM}^{e}\hat{ } and L_{q}\hat{ }. While the modification of the open-loop observer circuit embodiment of FIG. 2 to include an estimating circuit for L_{d} would be apparent to one of skill in the art, the embodiment of FIG. 2 is focused on accurately estimating magnetic flux linkage and q-axis inductance.

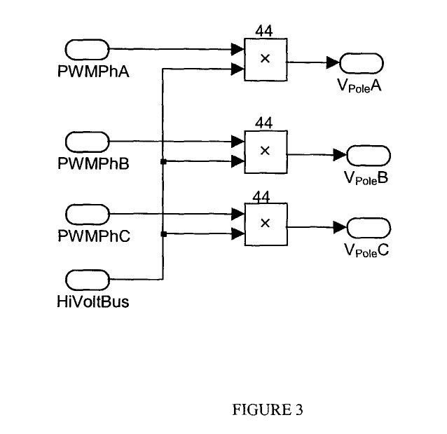

FIG. 3 is a schematic diagram of a preferred embodiment of an apparatus to perform the estimation algorithm used by the voltage calculator 36 to estimate the inverter pole voltages of the motor. The PWM duty cycle signals generated internally by the software of the PWM signal generator 34 are taken as inputs to the voltage calculator 36 along with the measured DC bus voltage. Each PWM signal is multiplied with the DC bus voltage at an amplifier 44. The result of the amplifiers 44 is the three-phase inverter pole voltages. These are then output to the voltage converter 38, as has been discussed earlier.

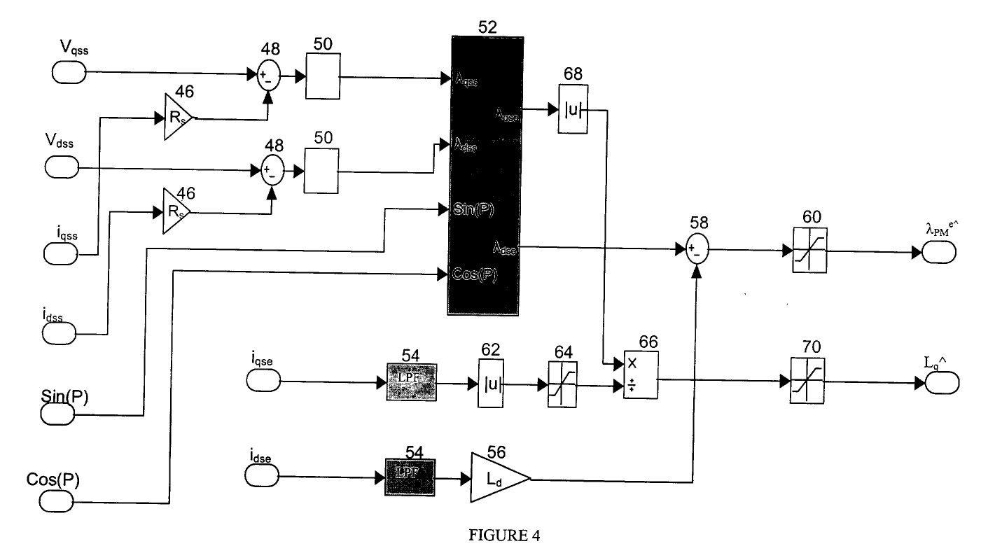

FIG. 4 is a schematic diagram of a preferred embodiment of an apparatus to perform the estimation algorithm used by open-loop flux observer 42 to estimate the magnetic flux linkage and q-axis induction, λ_{PM}^{e}\hat{ } and L_{q}\hat{ }. The algorithm performed by the apparatus of FIG. 4 uses the fundamental equations given in EQS. 2, 3, 4, and 5.

EQ. 3 shows that the magnetic flux linkages along d and q axis in the stationary reference coordinates are obtained by integrating the difference between the transformed two-phase stationary-reference motor voltages, V_{dss} and V_{qss} from the corresponding resistive voltage drops. Resistive voltage drops are determined by multiplying winding resistance, Rₛ, by the corresponding two-phase, stationary-reference currents, i_{dss} and i_{qss}. This multiplication is performed at amplifiers 46. Comparators 48 subtract the resistive voltage drops, or amplified current output from the amplifiers 46, in each axis direction from the corresponding voltage. The result obtained from the comparators 48 is the rate of changes of magnetic flux linkages with respect to time in each axis direction, as defined in EQ. 3.

Integrators 50 integrate the magnetic flux linkage rates of change output from the comparators 48 to yield the magnetic flux linkages along the d and q axes in the stationary reference coordinates, λ_{dss} and λ_{qss} respectively. These values are then transformed using a third vector rotation translator 52 into the synchronous reference coordinates. Preferably, the third vector rotation translator 52 utilizes a Park vector transformation algorithm, as is well-known in the art. The synchronous reference magnetic flux linkages along the d and q axes, λ_{dse} and λ_{qse}, are output by the third vector rotation translator 52.

Meanwhile, the motor currents, as expressed in synchronous reference coordinates, i_{dse} and i_{qse}, are processed. It is undesirable to transmit excess noise during the processing of these currents. To reduce the transmission of undesirable noises, i_{dse} and i_{qse} are passed to filters 54. Filters capable of processing these currents and effectively reducing noise are well-known in the art. Preferably, filters 54 are low-pass filters.

After filtering, i_{dse} is multiplied by L_{d}, the d-axis inductance, by amplifier 56. By subtracting this value from the value of λ_{dse} calculated by the third vector rotation translator 54 at comparator 58, the estimated magnetic flux linkage, λ_{PM}^{e}\hat{ }, is obtained. As earlier discussed, a limiter 60 is used to prevent the transmission of invalid values of λ_{dse}. Limiter 60 outputs the estimated magnetic flux linkage λ_{PM}^{e}\hat{ } to be used in the control method apparatus of FIG. 1.

Meanwhile, the filtered i_{qse} value is used in the estimation of q-axis inductance, L_{q}\hat{ }. The filtered i_{qse} value is first passed through an absolute value calculator 62, which calculates the absolute value of the q-axis synchronous reference current, as is well-known in the art. As above, i_{qse} is then passed through a limiter 64 to prevent the transmission of invalid values. At dividor 66, the q-axis magnetic flux linkage, λ_{qse}, which has already been passed through a second absolute value calculator 68, is divided by the limited absolute value of iqse received from limiter 64. This ratio between the absolute values of λ_{qse} and i_{qse} is the estimated inductance in the q-axis direction, L_{q}\hat{ } as defined by EQ. 2.

L_{q}\hat{ } is also passed through a limiter 70. Again, the purpose of this limiter is to prevent the transmission of invalid values of L_{q}\hat{ }. The output of limiter 70, the estimated q-axis inductance L_{q}\hat{ }, is then used in the control method apparatus of FIG. 1.

As has been discussed, dominant factors degrading the torque control accuracy in the prior art include material tolerance of the magnet, operating temperature variations, magnetic saturation, and airgap variations. The open-loop observer circuit 22 of the present invention is able to minimize the influence of these factors on the accuracy, as it estimates electrical parameters in real-time utilizing actual information of the machine electrical behaviors. While in the prior art, the expected torque control errors can be over ±28%, the expected torque control errors for a vector control system, such as the preferred embodiment of the present invention shown in FIG. 1, using an open-loop observer circuit 22 is estimated to be less than ±5%. The source of error remaining in use of the open-loop observer circuit 22 mainly arises from sensor material tolerances, digital quantitization errors during AC/DC conversion, and errors from low-pass filtering.

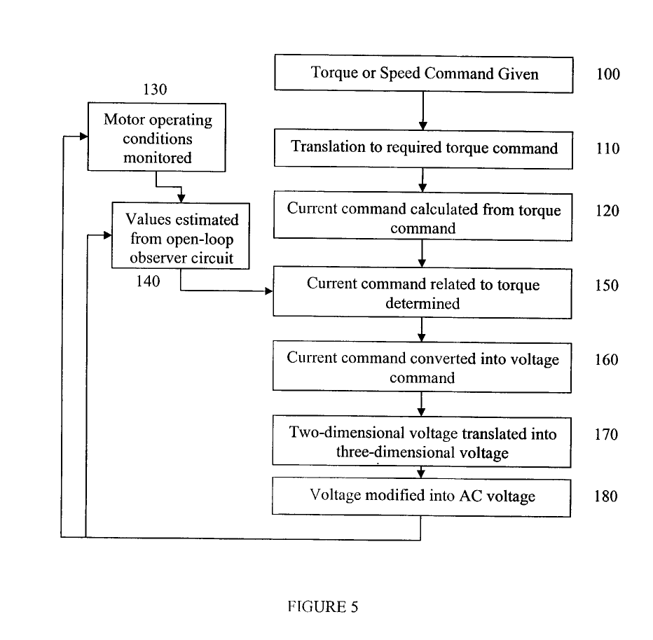

FIG. 5 is an overview flow diagram of one embodiment of the vector control process performed by the preferred embodiment of FIG. 1 or another embodiment of the present invention. First, a torque or speed command is given to the system and processed by the speed regulator 10 at Box 100. This torque or speed command may be one desired by the vehicle operator, or one required by a vehicular system such as the ISA or EPAS to maintain vehicle performance. The torque or speed command is then processed by the mode selector 14 at Box 110 to create a required torque command. The required torque command is the input to the flux current strategizer 18 at Box 120 to output a current command. Meanwhile, operating conditions of the motor, such as motor temperature, position, and speed, are monitored at Box 130, and fed to an open-loop observer circuit 22 at Box 140. The output values are sent to the current decoupler 20, where the portion of the current command related to torque, I_{q}*, can be determined at Box 150. The current regulator 30 converts the current command into voltage commands at Box 160. The voltage is transformed from a two-dimensional, synchronous vector representation to a three-phase, physical representation at the second vector rotator 32 at Box 170. The three phase representation of the voltage is modified by the PWM signal generator 34 into an AC voltage at Box 180 before being applied to the PM motor. The changes in motor operating conditions in applying the torque command to the PM motor are monitored back at Box 130 and Box 140, and the new conditions are input into a subsequent iteration.

Although the invention herein has been described in connection with a preferred embodiment thereof, it will be appreciated by those skilled in the art that additions, modifications, substitutions, and deletions not specifically described may be made without departing from the spirit and scope of the invention as defined in the appended claims.

1. A method for vector control of a permanent magnet synchronous motor, said method comprising the steps of:
providing estimated machine parameters via an open-loop observer circuit;
calculating a current command from a torque command using said estimated parameters;
translating said current command into a two-phase voltage command;
transforming said voltage command into a three-phase voltage command;
modulating said three-phase voltage command into a three-phase PWM command; and
applying said three-phase PWM command to a permanent magnet motor.

2. The method of claim 1, wherein said step of providing current commands for torque control further comprises:
sensing currents in said permanent magnet motor;
sensing voltages in said permanent magnet motor;
providing said open-loop observer circuit, taking said current and said voltage as inputs;
calculating values for magnetic flux and for inductance in said machine from said open-loop observer circuit; and
calculating current commands for torque control from said magnetic flux value and said inductance value.

3. The method of claim 2, wherein said step of calculating current commands for torque control is performed by a current decoupler.

4. The method of claim 2, further comprising the steps of:
receiving a speed command; and
converting said speed command into a required torque command,
said steps previous to said step of sensing the currents in said machine.

5. The method of claim 4, wherein said step of converting said speed command is performed by a mode selector.

6. The method of claim 1, wherein said step of calculating a current command is performed by a flux current strategizer.

7. The method of claim 1, wherein said step of regulating said current commands is performed by current regulators.

8. The method of claim 1, wherein said step of transforming said voltage command is performed by a vector rotator.

9. The method of claim 1, wherein said step of modulating said three-phase voltage is performed by a PWM signal generator.

10. A method for utilizing an open-loop observer circuit apparatus for control of a permanent magnet motor, said method comprising:
calculating three-phase inverter pole voltages from a plurality of input voltages and PWM duty cycle signals;
converting said three-phase inverter pole voltages into three-phase motor phase voltages;
transforming three-phase motor phase voltages into two-phase motor voltages; and
estimating electrical parameters of said permanent magnet motor from said two-phase motor voltages.

11. The method of claim 10, wherein said plurality of input voltages comprises:
the PWM duty cycle signals applied by a PWM signal generator to said permanent magnet motor; and
the DC bus voltage of the permanent magnet motor.

12. The method of claim 10, wherein said step of calculating three-phase inverter pole voltages is performed by a voltage calculator.

13. The method of claim 10, wherein said step of converting said three-phase inverter pole voltages is performed by a voltage converter.

14. The method of claim 10, wherein said step of transforming three-phase motor phase voltages is performed by a voltage transformer.

15. The method of claim 10, wherein said step of estimating electrical parameters is performed by an open-loop flux observer.

16. The method of claim 15, wherein said step of estimating electrical parameters further comprises:
calculating the estimated magnetic flux linkage; and
calculating the estimated inductance.

17. A method for calculating three-phase inverter pole voltages with a voltage calculator for control of a permanent magnet motor via an open-loop observer circuit, said method comprising:
providing as input a plurality of PWM duty cycle signals applied by a PWM signal generator and a DC bus voltage in said permanent magnet motor;
multiplying each of said plurality of PWM duty cycle signals by said DC bus voltage; and
outputting said multiplied voltages as three-phase inverter pole voltages.

18. The method of claim 17, wherein said plurality of voltages comprises three voltages.

19. The method of claim 17, wherein said step of multiplying each of said plurality of voltages is performed by an amplifier.

20. A method for estimating electrical parameters with an open-loop flux observer for control of a permanent magnet motor via an open-loop observer circuit, said method comprising:
calculating stationary-reference magnetic fluxes;
transforming said stationary-reference magnetic fluxes into synchronous reference magnetic fluxes;
filtering synchronous-reference currents; and
calculating said electrical parameters from said synchronous-reference magnetic fluxes and said synchronous-reference currents.

21. The method of claim 20, wherein said step of calculating stationary reference magnetic fluxes comprises:
providing as input stationary-reference currents;
calculating resistive voltage drops from said stationary-reference currents;
calculating rates of change of said stationary-reference magnetic fluxes from said resistive voltage drops and from stationary-reference voltages; and
integrating said rates of change of said stationary-reference magnetic fluxes to determine stationary reference magnetic fluxes.

22. The method of claim 21, wherein said step of calculating resistive voltage drops is performed by an amplifier.

23. The method of claim 21, wherein said step of calculating rates of change of said stationary-reference magnetic fluxes is performed by a comparator.

24. The method of claim 21, wherein said step of integrating said rates of change of said stationary-reference magnetic fluxes is performed by an integrator.

25. The method of claim 20, wherein said step of transforming said stationary-reference magnetic fluxes is performed by a vector rotator.

26. The method of claim 25, wherein said vector rotator uses a Park transform algorithm.

27. The method of claim 20, wherein said step of filtering synchronous-reference currents is performed by a low-pass filter.

28. The method of claim 20, wherein said step of calculating said electrical parameters further comprises:
calculating the estimated magnetic flux linkage; and
calculating the estimated inductance.
